(19) United States
(12) Patent Application Publication
(10) Pub. No.: US 2023/0371534 A1
(43) Pub. Date: Nov. 23, 2023

(54) Method and Apparatus for Preservation of Organic Products

(71) Applicant: Vernon Rainer Alva, Mumbai (IN)

(72) Inventor: Vernon Rainer Alva, Mumbai (IN)

(21) Appl. No.: 18/019,800

(22) PCT Filed: Apr. 30, 2021
(86) PCT No.: PCT/IB2021/053606

§ 371 Date: Feb. 4, 2023

(30) Foreign Application Priority Data
Jan. 30, 2021 (IN) 202021034074

(51) Int. Cl. A23B 7/055; A23B 4/09; A23L 3/26; A23L 3/375

(52) U.S. Cl. CPC A23B 7/055; A23B 4/09; A23L 3/263; A23L 3/375

(57) ABSTRACT

The present invention relates to a method and an apparatus for preservation of an organic product in a process plant. According to an aspect of the present invention, the method includes obtaining the organic product maintained at a predefined temperature. The organic product is enclosed within an apparatus that is inbuilt with one or more thermal insulation modules that facilitate maintaining a temperature of the organic product at the predefined temperature during the predefined time period. Further, the organic product is irradiated for a predefined time period effective to eradicate microbial contamination in the organic product.

### CROSS-REFERENCE TO RELATED APPLICATION

The instant application is related to pending Indian Patent Application No: 202021034074, titled, “METHOD AND APPARATUS FOR PRESERVATION OF ORGANIC PRODUCTS” and co-pending PCT Application No. PCTIB2021053606, with inventors Junia Suresh Alva and Vernon Rainer Alva, Filed: On 30 Jan. 2021 which is incorporated in its entirety herewith.

### FIELD OF THE INVENTION

The present invention relates generally to preservation of organic products. More particularly the present invention relates to methods and apparatus for preservation of organic products.

### BACKGROUND OF THE INVENTION

The chemical, pharmaceutical and food processing industries have been involved in various preservation techniques with a view to obtaining longer shelf life of perishable products such as gels, meat, seafood, vegetables, medicines, blood plasma, biological media and other such organic products. Apart from having a long shelf life of the organic products, it is essential to maintain a quality of the organic products during and after the preservation processes. Any deterioration in the quality of the preserved organic products defeats a purpose of preservation, as such products cease to be of optimum use.

The quality of the organic products depends on various properties of the organic products such as physiological, chemical, structural and biological properties. If the various properties are retained during preservation, the organic product obtained post preservation shall be of similar quality as that of a fresh organic product. Therefore, in order to maintain the quality of the organic product upon preservation, it is essential to retain the various properties of the organic product during and post preservation of the organic product.

Accordingly, there is a need for an improved process or method of preservation that maintains the properties of the organic products to provide organic products that are similar to fresh organic products, also referred to as refreshable organic products. Consequently, the improved method must also provide in a longer shelf life of the organic products than provided by existing methods of preservation. Hence an alternate method and apparatus for preservation of organic products is proposed that retains the properties during and post preservation and that enhances the shelf life of the organic products.

The abovementioned shortcomings, disadvantages and problems are addressed herein, which will be understood by reading and studying the following specification.

### SUMMARY OF THE INVENTION

An aspect of the invention provides a method for preservation of an organic product in a process plant. The organic product is at least one of but not limited to fish, meat, vegetables, fruits, roots, seeds, microbes, fungi, gels, biological media and blood plasma. The method includes obtaining the organic product in a frozen state; wherein the organic product is frozen up to a predefined temperature. Further, the organic product is enclosed within an apparatus inbuilt with one or more thermal insulation modules, and is irradiated for a predefined time period effective to eradicate microbial contamination in the organic product. For example, the organic product can be irradiated by at least one irradiating unit that directs gamma radiations, microwave radiations, electron-beam radiations, corpuscular radiations, electromagnetic radiations or a combination thereof. In an embodiment, the at least one irradiating unit is installed within the process plant, external to the apparatus, and the apparatus is moved over conveyor belts through the process plant while being subjected to the irradiations in a predefined manner.

The one or more thermal insulation modules facilitate maintaining a temperature of the organic product at the predefined temperature during the predefined time period. A temperature level inside the apparatus is also maintained at the predefined temperature during the predefined time period. The predefined temperature ranges from −40 to −195 degree Celsius, and the predefined time period ranges from 5 to 180 minutes, when a concentration of radiation for irradiating the organic product is selected from 0.3 to 50 kiloGray (kGy). Typically, the concentration of irradiation, the predefined temperature and the predefined time period is selected based on a type of the organic product.

In an embodiment the apparatus is made of a double walled container having an inner wall and an outer wall. One or more thermal insulation modules is disposed within an empty space existing between the inner wall and the outer wall. A thermal insulation module includes a gel pack, a phase change material (PCM) or a combination of both. A consistency of the one or more thermal insulation modules is adjustable based on the predefined temperature and a temperature external to the apparatus (for example, an ambient temperature of the process plant). In an embodiment, the predefined temperature is selectable from 0 to −195 and the temperature external to the apparatus can range from 0 to 55 degree Celsius. In another embodiment, a composition of a thermal insulation module is varied or adjusted to store heat energy proportional to a temperature difference of at least 250 degree Celsius between the thermal insulation module and an environment external to the apparatus. The consistency of the thermal insulation module can be varied by altering a composition of the thermal insulation module. For example, the composition of a PCM module can include one or more of an alpha aluminum oxide (AL₂O₃) nanoparticle dispersion, sodium polyacrylate, hydrocarbons, primarily paraffin, salt hydrates, hygroscopic, and polymers.

Further the apparatus includes at least one container located within an enclosed space contained by the inner wall. The at least one container is filled with a cooling agent comprising a gel pack, PCM, dry ice or a combination thereof, to facilitate maintaining the predefined temperature of the organic product. Typically, the organic product is accommodated around the at least one container within the enclosed space. For example, a hollow cylindrical container filled with dry ice can be installed at a center of the enclosed space, and the organic product can be placed circumferentially around the cylindrical container.

In an embodiment, prior to the irradiation, the organic product is sterilized at a first predefined temperature selectable from −10 to +5 degree Celsius. The first predefined temperature for sterilizing the organic product is usually based on a type and quantity of the organic product. Further, one or more cryoprotectants and cryostabilizers may be added to the organic product prior to the freezing, where a cryoprotectant can be one of a sucrose, chitosan, sorbate, acetic, oligochitosan, dissaccharides, glycerol, sorbitol, ascorbic acid, citric acid, amino acids, polyols, methyl amines, carbohydrates, and inorganic salts such as potassium phosphates, tripolyphosphate, and ammonium sulfate, carboxymethyl cellulose, gums or their combinations. Further, cryostabilizers can be selected from a group of polyols and/or polysaccharides. In an embodiment, a cryostabilizer can be one of a poly(ethylene glycol) (PEG), polyacrylamide, ficoll, pectin methylesterase and maltodextrin powder (DE=5-18). Addition of cryoprotectants and cryostabilizers to the organic product, protect the organic product from freezing damage, thereby facilitating retention of physiological, chemical, biological and structural properties during the preservation method.

In an embodiment, sterilization includes subjecting the organic product to a gaseous composition comprising a predefined proportion of ozone gas, and ultraviolet (UV) radiation in presence of a predefined humidity level within an enclosed chamber of the sterilization device. The UV radiation is provided by UV tube lights arranged inside the enclosed chamber such that entire area of the organic product is subjected to UV radiation. The predefined proportion of ozone, the predefined proportion of CO gas is based on operating information associated with sterilizing a plurality of types and quantities of the organic products within the enclosed chamber. Further, the gaseous composition includes a predefined proportion of Carbon Monoxide (CO) gas when the organic product contains myoglobin. The humidity level is selected in a range of, 98-100%, to prevent dehydration that occurs at low temperatures of −5 to +10 degree Celsius. As a result, moisture or normal water content is retained within the organic product during the sterilization that ensures freshness and longer shelf life.

Post sterilization, the organic product is sealed in at least one of a gas permeable bag and a high barrier bag in a sealing unit, where the gas permeable bag and the high barrier bag are composed of food grade packaging material. Typically the organic product is vacuum-sealed in a gas permeable bag first, and can then be vacuum-sealed again with the high barrier bag. The double packing ensures the freezing solvent does not come in contact with the organic product. As a result, any deterioration of the organic product that may occur due to interaction with the freezing solvent and additives used during the freezing process is eliminated. For example, the high barrier bag can be a nylon bag that is non-permeable in order to prevent air (oxygen), and/or liquid from passing through. As a result, spoilage from aerobic bacteria is prevented.

Subsequent to the sealing, the sealed organic product is immersed into a cooling bath filled with an aqueous solution maintained at a second predefined temperature selected from −20 to +2 degree Celsius, until a core temperature of the organic product reaches a temperature of the aqueous solution. In an embodiment, the aqueous solution is a brine solution, and food grade ice is used to maintain the brine solution at the second predefined temperature within the cooling bath.

After being immersed in the aqueous solution, the organic product is subjected to freezing up to the predefined temperature using a freezing device. In an embodiment, the organic product is introduced inside a tank of the freezing device, where the tank contains a freezing solvent maintained at the predefined temperature. The freezing solvent is at least one of an alcohol, alkane, alkene, aldehyde or an aqueous based solution. In an embodiment, the freezing solvent can include at least one inhibitor. For example, the freezing solvent can be one of ethanol, glycol, isopentane, 3-methylcyclohexene, 3-ethyltoluene, ethyl iodide, acetaldehyde or brine and the inhibitor can be selected from a group consisting of Polysorbate 80, monoacyl glycerol, octyl glucoside sodium chloride (NaCl), and calcium chloride (CaCl). For effective freezing of the organic product, a cryogen in a liquid or a gaseous form is passed into the freezing solvent through a permeable structure placed inside the tank.

A type of cryogen is selected based on the predefined temperature. Examples of cryogen that can be passed into the freezing solvent include but are not limited to helium, hydrogen, nitrous oxide, nitrogen, argon, oxygen, carbon dioxide, and Liquefied Natural Gas (LNG).

Further, the freezing solvent is circulated from the tank, through a liquid transmission means and back into the tank using a pump to maintain the freezing solvent at the predefined temperature, wherein the liquid transmission means and the pump are coupled externally to the freezing tank. Additionally, the freezing solvent is agitated using at least one agitator placed within the tank for breaking one or more heat layers around the organic product. The steps of passing cryogen, circulating the freezing solvent, and agitating the freezing solvent, are performed repeatedly until a core temperature of the organic product reaches the predefined temperature.

In an embodiment, post the freezing process the organic product can be stored in a cooling device maintained at 0 to −105 degree Celsius. The stored organic product is then subjected to the irradiation. In another embodiment, post the freezing process the organic product can be directly subjected to the irradiation. Further, post irradiation, the irradiated organic product is stored in a cooling device maintained at a third predefined temperature selectable from −15 to −105 degree Celsius. When stored at the third predefined temperature the irradiated organic product has a first shelf life of up to 10 years based on a type of the organic product. It is observed that organic product retains the physiological, chemical, biological and structural properties of the organic product during the first shelf life.

Typically, the organic product is taken from the cooling device and thawed or tempered before being utilized. In order to maintain firmness and quality and texture, the organic product is thawed at −5 to 0 degree Celsius. Post tempering, the high barrier bag is cut open or removed and the organic product is stored at a temperature range of −2 to 5 degrees. It is observed that the organic product has a second shelf life of 7 days to 2 years based on the type, when stored at the temperature range −2 to 5 degree Celsius. The gas permeable bag ensures toxins and spoilage does not occur due to anaerobic bacteria such as Clostridium botulinum. Further, it is observed that organic product retains the physiological, chemical, biological and structural properties of the organic product during the second shelf life. A freshness level of the organic product during the second shelf life is similar to a freshness level of the organic product when procured in a fresh state prior to subjecting the product to the disclosed method of preservation.

Another aspect of the invention provides an organic product having a first shelf life of up to 10 years when stored at a temperature selectable from −15 to −105 degree Celsius; and a second shelf life of 7 days to 2 years when stored at a temperature selectable from −2 to 5 degree Celsius. The first shelf life and second shelf life is based on a type of the organic product. The organic product retains one or more physiological, chemical, biological and structural properties of the organic product during the first shelf life and the second shelf life.

In order to obtain the organic product having aforementioned first shelf life and second shelf life, the organic product obtained in a fresh state is subjected to one or more methods of preservation. The methods of preservation include, sterilizing the organic product at a first predefined temperature, wherein the first predefined temperature are based on a type and quantity of the organic product, wherein the first predefined temperature is selectable in a range of −10 to +5 degree Celsius, immersing the organic product into an aqueous solution maintained at a second predefined temperature selected from −10 to −2 degree Celsius, until a core temperature of the organic product reaches the temperature of the aqueous solution, freezing the organic product up to a predefined temperature selectable from a range of −40 to −195 degree Celsius, wherein the predefined temperature is based on a type and a composition of the organic product. Further, the organic product is enclosed within an apparatus configured to maintain a temperature of the organic product at the predefined temperature for a predefined time period; during which the organic product is irradiated with at least one irradiating unit provided external to the apparatus. In an embodiment, the predefined time period is selectable from a range of 5 to 180 minutes, and the concentration of radiation required for irradiating the organic product is selectable from a range of 0.3 kGy to 50 kGy, based on a type of the organic product.

Another aspect of the invention provides, an apparatus for facilitating preservation of an organic product in a process plant is disclosed. The apparatus comprises a double walled container comprising an inner wall and an outer wall composed of an aluminum, carbon steel, iron material, fiberglass, stainless steel or a combination of aforesaid materials. The organic product is contained within an enclosed space contained within the inner wall. In an embodiment, at least one portion of a surface of the double walled container is openable or has an opening to facilitate introduction of the organic product into the enclosed space. For example, a door may be provided in the double storage container, through which the organic product is introduced into the enclosed space. Further, the organic product is insulated by packing within an insulated structure (for example a cardboard box). The product is subjected to freezing up to a predefined temperature of −40 to −195 degree Celsius, prior to the packing and the introduction into the enclosed space.

Further, the double walled container comprises at least one container disposed within the enclosed space. The at least one container is filled with a cooling agent such as gel pack, PCM, dry ice or a combination thereof, and is configured to facilitate maintaining the temperature of the organic product at the predefined temperature for the predefined time period. In an embodiment, the at least one container is composed of one or more of an aluminum, carbon steel, iron, fiberglass, steel and a combination thereof. Furthermore, the double walled container includes one or more thermal insulation modules disposed within a space existing between the inner wall and an outer wall, and wherein a thermal insulation module comprises a phase change material (PCM), a gel pack or a combination of both. In an embodiment, where a temperature external to the apparatus which is the temperature of an external environment (for example ambient temperature of the process plant) is higher than a temperature at which the organic product is to be maintained which is the predefined temperature, the one or more thermal insulation modules are configured to absorb heat from the external environment and undergo a phase change and thereby prevent heat from entering the apparatus. As a result, any change in temperature of the enclosed space is avoided. Consequently, a constant temperature is achieved within the enclosed space which in turn facilitates maintaining a temperature of the organic product constant at the predefined temperature.

Alternatively, if a temperature within the apparatus (or the temperature of the enclosed space) or the predefined temperature of organic product is higher than the temperature of the external environment, the one or more thermal insulation modules can undergo a similar phase change and absorb heat and prevent heat energy from the enclosed space to flow towards the external environment. In an example, where the predefined temperature of the organic product is selectable in a range of 0 to −195 degree Celsius and the temperature external to the apparatus ranges from 5 to 55 degree Celsius, the thermal insulation module absorbs heat from an external environment and thereby maintains the predefined temperature.

In another example, the organic product enclosed within the apparatus can be irradiated by one or more radiations emitted by at least one irradiating unit (1014) (for example, a gamma radiation unit, an electron-beam emission unit, a microwave radiation unit, an electromagnetic radiation unit, a corpuscular radiation unit) installed within a process plant for the predefined time period. When a concentration of 0.3 kiloGray (kGy) to 50 kGy of radiation is provided to the organic product for a predefine time period selected from 5 to 180 minutes, the one or more thermal insulation modules of the apparatus undergo a phase transition to maintain the organic product at the predefined temperature selected in a range of −40 to −195 degree Celsius, when the temperature external to the apparatus ranges from 5 to 55 degrees Celsius.

Further, a composition of the gel pack and the PCM, as the case may be, is adjusted in a manner to store heat energy proportional to a temperature difference of at least 250 degree Celsius between the thermal insulation module and an environment external to the apparatus. In operation, a consistency of the gel pack or the PCM determines a capacity of the thermal insulation module to store heat energy, and the consistency is based on the composition of the thermal insulation module.

In an embodiment, the composition of the gel pack comprises a superabsorbent polymer, water and alcohol, where a ratio of the water to the alcohol is 1:4. Examples of superabsorbent polymer include but are not limited to polyacrylate, ethylene maleic anhydride copolymer, cross-linked carboxymethylcellulose, and polyacrylonitrile. In another embodiment, where the thermal insulation module comprises of PCM, a composition of the PCM includes a hydrogel, filling agent and one or more nanoparticles. Examples of the hydrogel include but are not limited to a group consisting of (1-ethyl-3-(3dimethylaminopropyl) carbodimide hydrochloride) (EDC) and N-Hydroxysuccinimide (NHS), acrylate monomers salts of sodium or potassium (for example sodium polyacrylate), Poly(γ-glutamic) Acid (PGA) crosslinked by L-lysine and Gellan gum with Jeffamine 130, and polyacrylamide. Further, the filling agent is selected from the group consisting of an alcohol, alkene, alkyne, aldehyde, paraffin, fatty acid, and aqueous based solutions, and the nanoparticles is selected from the group consisting of aluminum (Al), Copper (Cu), Silicon dioxide (SiO₂), Titanium Oxide (TiO₂), Carbon nanotubes (CNT), Carbon nanofibers (CNF), aluminum oxide (Al₂O₃), Sodium Hydroxide (NaOH), Potassium Hydroxide (KOH), Cupric oxide (CuO) and Zinc Oxide (ZnO).

For example, if the temperature external to the apparatus is 40 degree Celsius and the one or more PCM modules are required to maintain the predefined temperature of the organic product at −195 degree Celsius, then for the PCM module to withstand a temperature difference of 235 degree Celsius and provide the desired thermal insulation, 12% solution of sodium polyacrylate with 4% of alpha aluminum oxide (Al₂O₃) nanoparticles is added to the PCM. Hence in order to achieve varied thermal insulation properties based on the temperature external to the apparatus and the predefined temperature the composition of the one or more thermal insulation modules can be adjusted accordingly.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

FIG. 1 is a process diagram depicting a process flow for preserving an organic product, according to an embodiment of the present invention.

FIG. 2 is a sterilization device, according to an embodiment of the present invention.

FIG. 3 is a freezing device, according to an embodiment of the present invention.

FIG. 4 is schematic diagram of an apparatus for facilitating preservation of an organic product in a process plant, according to an embodiment of the present invention.

FIG. 5 is a flowchart illustrating a method for preservation of an organic product, according to an embodiment of the present invention.

FIG. 6 is a flowchart illustrating a method for preservation of an organic product, according to another embodiment of the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense. The various embodiments of the present invention provide a method and apparatus for preservation of organic products.

The present invention is related to a method and apparatus for preserving an organic product in a process plant to obtain an organic product (hereinafter referred to as preservable organic product) that has an improved shelf life and that retains properties similar to the organic product when obtained in a fresh state. The preservable organic product can be produced only when a fresh organic product or an organic product having a freshness level above a predetermined threshold is provided as an input to the method and the apparatus. In an embodiment, an organic product having the freshness level above the predetermined threshold is subjected to a method of preservation to obtain the preservable organic product. In an embodiment, the organic product is subjected to sterilization at −10 to +5 degrees Celsius, is vacuum-sealed in a gas permeable bag and/or a high barrier bag, is subjected to freezing up to a predefined temperature selectable from −40 to −195 degree Celsius, is enclosed within an apparatus and is subjected to irradiation within a process plant (for example, a radiation process plant having a plurality of irradiating units that emit one or more types of radiations). The temperature of the organic product is maintained constant at the predefined temperature (for example, the predefined temperature is selectable in a range of −40 to −195 degree Celsius) during the irradiation process. In an embodiment, the organic product is at least one of fish, seafood, meat, poultry, vegetables, fruits, roots, seeds, microbes, fungi, albumin, milk, proteins, gels, biological media and blood plasma.

For example, in case of a fish process plant, only fish fillets having a reasonably good level of freshness and quality are selected for processing through the process plant for producing preservable fish fillets. The quality and freshness of the fish fillets are measured using a fish freshness meter (e.g. a Torry meter). Typically, the Torry meter measures a conductance, capacitance and Q-factor of flesh and muscle structure of each fish fillet to measure the freshness of the fish fillet. A reading of 14-16 on the Torry meter is considered a good level of freshness and hence a benchmark for accepting the fish fillet for processing through the fish process plant.

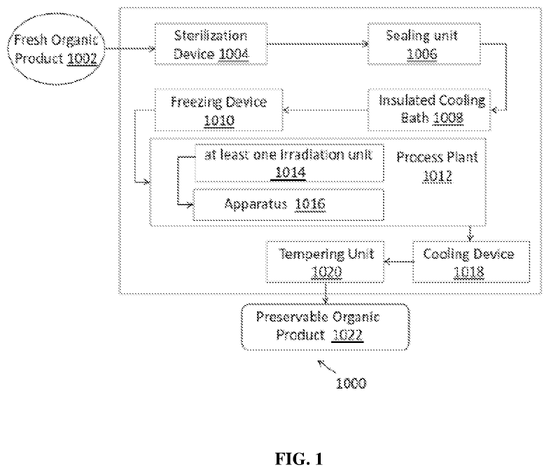

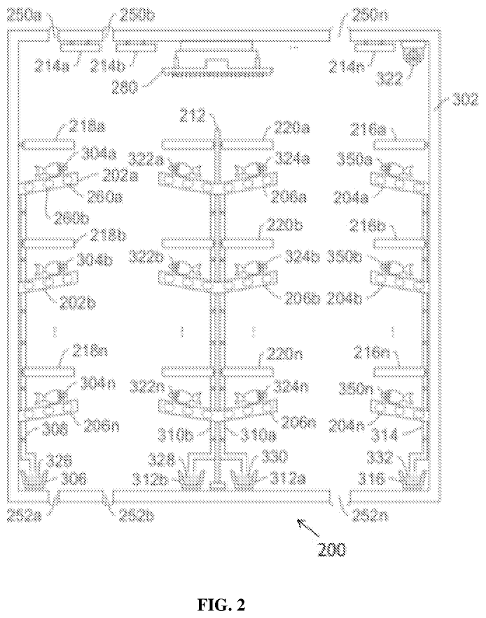

A process of preservation is depicted in FIG. 1, where a fresh organic product 1002 is passed through various units and devices. An output of the process plant is a preservable organic product 1022 that bears similar physiological, chemical, biological and structural properties, and freshness level as that of the fresh organic product. In an embodiment, the preservable organic product obtains a first shelf life of up to 10 years when stored at a temperature of −15 to −105 degree Celsius, and a 25 second shelf life of 7 days to 2 years when stored at low temperatures, such as −2 to 5 degree Celsius. The aforementioned properties and freshness level of the preservable organic product are retained during the first shelf life and the second shelf life. Details of the process flow for producing the preservable organic product within the process plant is explained in reference to FIG. 1.

FIG. 1 is a block diagram 1000, illustrating the process flow for preserving the organic product 1002. As shown, the process flow includes passing the fresh organic product (1002) through a sterilization device 1004, a sealing unit 1006, an insulated cooling bath 1008, a freezing device 1010, a process plant 1012 containing at least one irradiating unit 1014 and an apparatus 1016, a cooling device 1018 and a tempering unit 1020 in order to obtain a preservable organic product (1022).

As shown, the sterilization device sterilizes the fresh organic product 1002. The fresh organic product may include but is not limited to fish, meat, vegetables, fruits, roots, seeds, microbes, fungi, blood plasma, gels, biological media and other biodegradable products. Usually, the fresh organic product is an organic product that has a freshness level above a predetermined threshold. The fresh organic product can be obtained from a freshness detection unit (not shown in FIG. 1). For example, in case of a fish process plant, a plurality of fish fillets obtained from various fish providers, are washed with ozonized water, and checked for a freshness level using a Torry meter within the freshness detection unit. Samples of fish that have a freshness level above the predetermined threshold (e.g. a reading of 12-14 on the Torry meter) are passed into the process for undergoing the process of preservation.

In an embodiment, the fresh organic product (e.g. fish fillets), hereinafter referred to as the organic product, can be placed on an insulated closed trolley, and transferred into the sterilization device. The organic product is sterilized at a first predefined temperature selectable from −10 to +5 degree Celsius, wherein the first predefined temperature is based on a type and quantity of the organic product. Further, the organic product can be sterilized for a specific time period, where the specific time period is dependent on a type and quantity of the organic product. For example, 50 kilograms of salmon can be sterilized effectively within a chamber of the sterilization device at −2 degree Celsius for a duration of 30 minutes.

While many configurations of the sterilization device is envisaged, in an embodiment, a sterilization device 200 disclosed in FIG. 2 can be used for sterilizing the organic product. As shown in FIG. 2, the sterilization device 200 includes an enclosed structure (302 see FIG. 2) (e.g. a closed room or a chamber) inside which the organic product is sterilized at the first predefined temperature (e.g. −2 degree Celsius) and at a particular humidity level (98-100%).

FIG. 2 is a front cross-sectional view of the example sterilization device 200. In an embodiment, as shown a plurality of samples (304a-n, 324a-n, 322a-n and 350a-n) of the organic product can be sterilized within the sterilization device. The plurality of samples of the organic product is picked up manually using sterilized gloves or is picked up automatically by a crane machine arrangement and placed on shelves (202a-n, 204a-n, 206a-n) provided within an enclosed structure 302. The enclosed structure comprises a plurality of ultraviolet tube lights (214a-n, 218a-n, 216a-n, and 220a-n) and a plurality of inlets (250a-n) and outlets (252a-n) provided for circulation of a gaseous composition used for sterilizing the plurality of samples of the organic product.

The UV radiation helps eradicate and kill various pathogenic bacteria, fungi, and other microbes within the plurality of samples. Further the gaseous composition comprising a predefined proportion of ozone gas also kills the plurality of microbes and pathogens within the samples. Aforesaid sterilization is done in presence of a predefined humidity level (e.g. 98-100% of humidity) that helps retain moisture content within each sample of the organic product. In an embodiment, the first predefined temperature, the specific time period and the predefined proportion of ozone is obtained from a model, stored within a memory of a controller that operates the sterilization device.

Once the sterilization process is complete, an exhaust valve of the enclosed structure is opened through which the gaseous composition is vented out. Upon venting out the gaseous composition from the enclosed structure, another sterilized insulated trolley is introduced into the structure. The plurality of samples of the organic product are picked up and placed onto the other insulated trolley. The other insulated trolley is then trolled out of the enclosed structure. In an example, the other trolley is maintained at the temperature of −2 degree Celsius.

Further, the plurality of samples of the organic product can be transferred (for example, via the other insulated trolley) into the sealing unit 1006. Each sample of the organic product is vacuum-sealed in a gas permeable bag (e.g. 10K Oxygen transmission rate (OTR) bag) and a high barrier bag (a gas impermeable bag or a nylon bag) within the sealing unit. The high barrier bag prevents atmospheric air to come in contact with the organic product, thereby preventing aerobic pathogens from deteriorating the organic product. The gas permeable bag permits atmospheric air to pass through and come in contact with the organic product when the high barrier bag is cut open. Typically, the high barrier bag is cut open, upon completion of the method of preservation. Hence, each sample of the preservable organic product remains sealed within the gas permeable bag during distribution and transportation to an end user. As the gas permeable bag permits flow of oxygen or air, deterioration and toxin formation due to anaerobic pathogens (e.g. Clostridium botulinum) is eliminated during the transportation and distribution. The unique combination of gas permeable bag and the high barrier bag, thereby ensures prevention of spoilage from all types of bacteria, anaerobic and aerobic.

Further, the each sample of the organic product is immersed into the insulated cooling bath 1008 hereinafter cooling bath maintained at a second predefined temperature selected from −20 to +2 degree Celsius. In an embodiment, the cooling bath is filled with brine solution and food grade ice is used to maintain the second predefined temperature. The food grade ice is manufactured by using salt in purified (distilled or reverse osmosis water), and freezing water maintained at −2 degree Celsius. A digital probe is used to test that the ice is free from any pollutant and is food grade. The samples are kept in the tub, until a core temperature of the each sample reaches the second predefined temperature range mentioned above. In an embodiment, a temperature probe can be inserted inside one of the samples (a test sample), and the temperature recorded may be monitored to determine when a core temperature of the test sample reaches the second predefined temperature. When the core temperature of the test sample is reaches the second predefined temperature, the remaining samples are removed from the cooling bath and transferred to the freezing device.

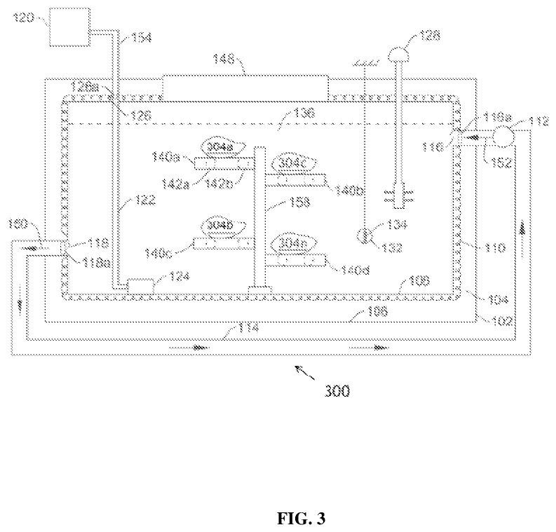

In the freezing device, the plurality of samples of organic product are subjected to freezing up to a predefined temperature selectable from 0 to −195 degree Celsius. Post freezing, the plurality of samples of the organic product can be referred to herein as a plurality of frozen samples of the organic product or a frozen organic product. Typically, the predefined temperature is selected based on the type and composition of the organic product. Various configurations of freezing devices capable of freezing the organic product up to the predefined temperature can be used. In an embodiment, an example freezing device 300 as shown in FIG. 3, is used for freezing the organic product.

In an embodiment, as shown in FIG. 3 the freezing device 300 is used for freezing a portion of the plurality of samples of the example organic product (304a-n). In another embodiment, not shown, the plurality of samples (304a-n, 324a-n, 322a-n and 350a-n) can be subjected to freezing together within the freezing device 300. The portion of the plurality of samples are introduced inside a tank 102 of the freezing device 300, where the tank contains a freezing solvent 136 set and maintained at the predefined temperature. In an embodiment, a cooling unit circulates a refrigerant to cool the freezing solvent up to the predefined temperature. Generally, each sample is at a temperature higher than the predefined temperature. For example, the each sample can be at −2 degree Celsius, and the freezing solvent can be at −195 degree Celsius.

The freezing solvent is at least one of an alcohol, alkane, alkene, aldehyde or an aqueous based solution. In an embodiment, the freezing solvent can include at least one inhibitor. For example, the freezing solvent can be one of ethanol, glycol, isopentane, 3-methylcyclohexene, 3-ethyltoluene, ethyl iodide, acetaldehyde or brine and the inhibitor can be selected from a group consisting of Polysorbate 80, monoacyl glycerol, octyl glucoside sodium chloride (NaCl), and calcium chloride (CaCl). In another example, the freezing solvent can be an aqueous solution of ethyl alcohol and the at least one inhibitor can be sodium chloride (NaCl), calcium chloride (CaCl) or a combination of both.

Further, a cryogen is passed into the freezing solvent in a liquid form, in a gaseous form (example, in a form of bubbles) or a combination of both forms by using a permeable structure (124) placed inside the tank. In an example, the cryogen is provided to the permeable structure in a gaseous form, a liquid form, or a combination of both forms through at least one inlet port 126 of the tank. A form of the cryogen is selected based on the predefined temperature. Examples of cryogen that can be passed into the freezing solvent include but are not limited to helium, hydrogen, nitrogen, nitrous oxide, argon, oxygen, carbon dioxide, and Liquefied Natural Gas (LNG).

The permeable structure can be a sparger, a bubble generator or a nano membrane depending on the form in which the cryogen is passed into the freezing solvent. Typically, a gaseous form of the cryogen is passed through the bubble generator, and a liquid form of the cryogen is passed through the sparger (example, a sintered sparger having pores of size of 0.1 micron). The bubbles generated by the permeable structure (bubble generator or the sparger) are of size of 0.1 micron. The bubbles facilitate uniform reduction in the temperature of the freezing solvent and consequently uniform cooling of the each sample of the organic product in a short span of time. In an example, the freezing solvent can be ethyl alcohol and the cryogen can be nitrogen passed in a gaseous form or a liquid form.

Further, the freezing solvent is circulated from the tank, through a liquid transmission means 114 and back into the tank using a pump 112 to maintain the freezing solvent at the predefined temperature, where the liquid transmission means and the pump are coupled externally to the freezing tank. In an embodiment, the freezing solvent is agitated within the tank during the freezing using at least one agitator 128 placed within the tank. Further, the steps of passing nitrogen, circulating the freezing solvent, and agitating the freezing solvent, are performed continuously until a core temperature of the each sample of the organic product reaches the predefined temperature.

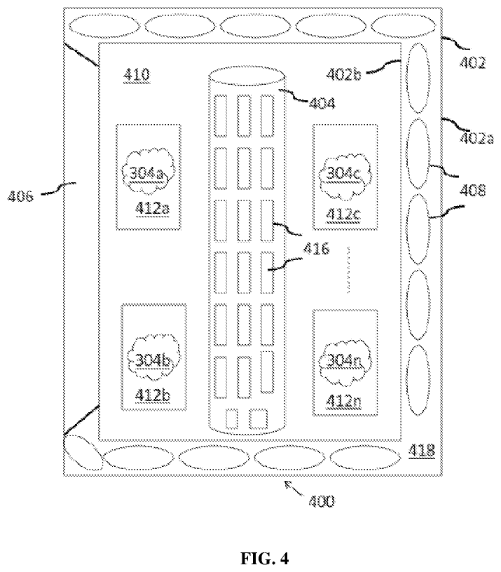

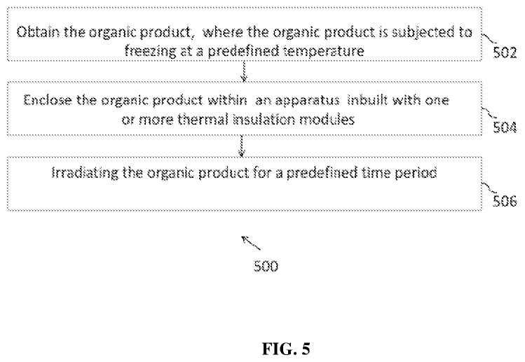

When the each sample reaches the predefined temperature, the freezing process is considered complete. Upon completion of the freezing process in the freezing device 1010, the organic product 1002 is introduced into the process plant 1012. In the process plant, the each sample of the organic product is enclosed within an apparatus (for example apparatus 1016 as shown in FIG. 4), that is exposed to radiations (for example gamma radiations) emitted from irradiating unit(s) (for example at least one irradiating unit 1014 of FIG. 4) of the process plant. Primary objective of the apparatus is to maintain the predefined temperature of the each sample of the organic product during the irradiation. While various constructions of the apparatus can be envisaged to achieve the aforementioned objective, an example construction of the apparatus is shown in FIG. 4.

FIG. 4 illustrates a block diagram 400 of the apparatus 1016 used for irradiation of the portion of the plurality of samples (304a-n) of the organic product. As shown the samples (304a-n) is packed in insulated structures (412a-n) (for example, cardboard box) within the apparatus. In another embodiment, (not shown) a larger number of samples such as the plurality of samples (304a-n, 322a-n, 324a-n, and 350a-n) can be subjected to irradiation within the apparatus 1016. The apparatus includes a double walled container 402 having an inner wall 402b and an outer wall 402a, one or more thermal insulation modules 408, at least one container 404, cooling agent 416, and an opening 406 within the double walled container. The double walled container can be composed of aluminum, carbon steel, iron material, fiberglass, a stainless steel material or a combination thereof. The opening provided in the double walled container can be a door that can be opened for introducing the organic product into an enclosed space (410) contained by the inner wall of the double walled container. Further, the at least one container can be a hollow cylinder (as shown in FIG. 4) and can be composed of aluminum, carbon steel, iron material, fiberglass, a steel material or a combination thereof.

As shown, the one or more thermal insulation modules (for example phase change material (PCM) modules) are disposed within a space (418) existing between the inner wall and outer wall of the double walled container. A thermal insulation module comprises a phase change material (PCM), a gel pack or a combination of both. In another embodiment, a single contiguous thermal insulation module may be packed in the space between the inner wall and the outer wall. Usually, a thermal insulation module is cooled up to the predefined temperature prior to disposing the thermal insulation module within the space. As a result, each of the one or more thermal insulation modules help maintain the temperature of the organic product at the predefined temperature and also a temperature of the enclosed space contained by the double walled container around the predefined temperature for a predefined time period.

Generally, with the passage of time, a temperature external to the apparatus (for example, temperature of the process plant) tends to influence the temperature of the enclosed space and the temperature of the organic product within the apparatus by a normal process of convection. However provisioning of the one or more thermal insulation modules as shown in FIG. 4 in the apparatus prevents such influence in the temperature of the organic product. Accordingly, the temperature within the enclosed space is maintained constant and thereby the temperature of the organic product is maintained at the predefined temperature for the predefined time period. Typically the one or more thermal insulation modules absorb sufficient energy at phase transition to provide useful cooling effect required within the apparatus. For example, a PCM module is capable of storing large amounts of energy compared to other heat storage materials and/or devices during phase transition and undergoes melting or solidifying at a phase change temperature (PCT). Hence when a temperature difference between the predefined temperature and the temperature external to the apparatus is huge the one or more thermal insulation modules is configured to absorb sufficient heat energy from the external environment without undergoing structural deterioration.

Further, a composition of the gel pack and the PCM, as the case may be, is adjusted in a manner to store heat energy proportional to a temperature difference of at least 250 degree Celsius between the thermal insulation module and an environment external to the apparatus. In operation, a consistency of the gel pack or the PCM determines a capacity of the thermal insulation module to store heat energy, and the consistency is based on the composition of the thermal insulation module.

In an embodiment, the composition of the gel pack comprises a superabsorbent polymer, water and alcohol, where a ratio of the water to the alcohol is 1:4. Examples of superabsorbent polymer include but are not limited to polyacrylate, ethylene maleic anhydride copolymer, cross-linked carboxymethylcellulose, and polyacrylonitrile. In another embodiment, where the thermal insulation module comprises of PCM, a composition of the PCM includes a hydrogel, filling agent and one or more nanoparticles.

Examples of the hydrogel include but are not limited to a group consisting of (1-ethyl-3-(3dimethylaminopropyl) carbodimide hydrochloride) (EDC) and N-Hydroxysuccinimide (NHS), acrylate monomers salts of sodium or potassium (for example sodium polyacrylate), Poly(γ-glutamic) Acid (PGA) crosslinked by L-lysine and Gellan gum with Jeffamine 130 and polyacrylamide. Examples of the filling agent include an alcohol, alkene, alkyne, aldehyde, paraffin, fatty acid, and aqueous based solutions. Examples of the filling agent include but are not limited to ethanol, ethylene glycol, propylene glycol, sodium chloride (NaCl), sodium nitrate (NaNO₃), aqueous ethylene glycol, Cyclohexane, Trichloroethylene, Nitroethane, Acrylonitrile, Acetaldehyde, Chlorobenzene, Butyl bromide, Pyridine and n-Propyl iodide. Furthermore, the nanoparticles is selected from the group consisting of aluminum (Al), Copper (Cu), Silicon dioxide (SiO₂), Titanium Oxide (TiO₂), Carbon nanotubes (CNT), Carbon nanofibers (CNF), aluminum oxide (Al₂O₃), Sodium Hydroxide (NaOH), Potassium Hydroxide (KOH), Cupric oxide (CuO) and Zinc Oxide (ZnO). The aforementioned nanoparticles are known to increase a thermal conductivity of the PCM with a minimal decrement in a heat storage capacity of the PCM. Further, disclosed nanoparticles act as an anti-freezing depressant and improve a solidification process of the hydrogels. As a result, the PCM obtains an enhanced heat storage capacity and capability to withstand higher temperature ranges as mentioned above.

In an example, a PCM module, can withstand temperature difference of at least 250 degree Celsius when composed of 75-90% concentration of aqueous ethanol solution mixed with (1-ethyl-3-(3dimethylaminopropyl) carbodimide hydrochloride) (EDC) and N-Hydroxysuccinimide (NHS) and doped with 0.5-4% of alpha aluminum oxide (AL2O3) nanoparticles. The particle size of AL2O3 can range from 0.1 to 10 micrometer. In another example, the PCM module may include 12% of EDC polyacrylate with 3% of alpha aluminum oxide nanoparticles for withstanding a temperature difference of 220 degree Celsius.

In an embodiment, the temperature external to the apparatus can range from 5 to 40 degree Celsius, the predefined temperature can be selectable from a range of −40 to −195 degree Celsius, and the predefined time period can be selectable from a range of 5 to 180 minutes. For example, if the temperature external to the apparatus is 35 degrees Celsius, and the organic product is to be maintained at −150 degrees Celsius, the one or more PCM modules is configured tolerate a temperature difference of 185 degrees Celsius between the temperature external to the apparatus and the temperature of the enclosed space or the predefined temperature, by undergoing phase transition. In this case, a consistency of the one or more PCM modules is adjusted to store heat energy proportional to a temperature difference between the one or more PCM modules and the external environment.

Further as shown in FIG. 4, the at least one container can include a hollow cylindrical structure that is located centrally within the space and is filled with a cooling agent 416. The cooling agent can be dry ice, gel packs, Phase Change Material (PCM) or a combination thereof. The cooling agent further facilitates maintaining the temperature of the organic product at the predefined temperature for the predefined time period. In another embodiment, a plurality of containers filled with the cooling agent such as PCM, may be installed at a plurality of locations within enclosed space of the apparatus, to facilitate maintaining the temperature of the enclosed space around the predefined temperature and the organic product at the predefined temperature. Such a unique arrangement of having the organic product packed between a plurality of PCM modules is essential in maintaining the below freezing temperatures (example, 0 to −195 degrees Celsius) during the irradiation process.

Further, as aforementioned, during the predefined time period the organic product is subjected to irradiation by the at least one irradiating unit installed within the process plant. In an embodiment, the at least one irradiating unit is one of a gamma radiation unit, an electron-beam emission unit, a microwave radiation unit, an electromagnetic radiation unit, and a corpuscular radiation unit. The predefined time period and a concentration of the radiation is based on a type of the organic product. For example, the predefined time period is selected from a range of 5 to 180 minutes and a concentration of the radiation is selected from 0.3 kGy to 50 kGy. For example, a concentration of a gamma radiation required for radiating refrigerated or frozen ground meat, meat byproducts, or both meat and meat byproducts is typically in a range of 0.3 kGy to 7 kGy.

A technical advantage of irradiating the organic product at below freezing temperature, facilitates eradiation of microbial contamination without loss of quality and deterioration of the organic product. Generally, irradiation tends to increase a temperature of the organic product, and this results in deterioration of quality of the organic product and increase in microbial growth. Disclosed apparatuses and methods of preservation, facilitate maintaining the organic product at a constant predefined temperature (for example, −40 to −195 degrees Celsius) during the irradiation process. As a result, disclosed methods and apparatuses provide an effective means for inactivating or killing microorganisms from various organic products especially food products. For example, freezing an organic product such as shrimp to below freezing temperatures such as −40 to −195 degree Celsius, followed by gamma radiation at the below freezing temperatures results in a greater than 5 log reduction of pathogenic bacteria such as Salmonella, and such reduction in pathogenic bacteria is maintained for at least 2 years at a cold storage of −20 degree Celsius. In other words, a first shelf life of such frozen and irradiated shrimp at −20 degree Celsius is 2.5 years. Further, when tempered at −2 degree Celsius, the characteristics, freshness level and organoleptic properties of such irradiated shrimp is similar to that of a fresh shrimp. Post tempering, the shrimp maintains a second shelf life of at least 15 days at 2 degree Celsius storage.

Disclosed methods results in considerable improvement of shelf-life without changing the chemical, biological, structural and physiological properties of the fresh organic product. For example, a shelf life of pre-climacteric fruits such as mangoes is extended from 7 days to up to 1 year, when irradiated with a low dose of gamma irradiation of 0.2 kGy for a predefined time period of 60 minutes and when maintained at a constant temperature of −40 degree Celsius during the irradiation process.

Another advantage of maintaining constant below freezing temperatures during irradiation of the organic products, is lesser dose of radiation is required for inactivating and killing the microorganisms, and alternatively lesser dose of radiation is required for achieving the extended shelf life (the first shelf life and the second shelf life). For example, a low dose of 0.1 kGy of gamma radiation of fruits maintained at −40 degree Celsius during the radiation, is sufficient for inactivating and killing the microorganisms in the fruits and for obtaining the first shelf life of at least 24 months when stored at −20 degree Celsius.

Upon completion of the irradiation, the organic product is removed through the opening and is stored in the cooling device 1018 (see FIG. 1) that is maintained at a third predefined temperature selected from −15 to −105 degree Celsius. The irradiated organic product is preservable for an extended time duration based on a type of the organic product. In other words, the irradiated organic product obtains a first shelf life of up to 10 years based on a type of the organic product when stored at a temperature selectable from −15 to −105 degree Celsius, where the first shelf life is based on a type of the organic product. For example, when 25 kilograms of salmon maintained at a predefined temperature of −40 degree Celsius is gamma radiated at a concentration of 2.5 kGy for 30 minutes, the shelf life of the irradiated organic product at least 36 months when stored at −40 degree Celsius post the gamma radiation. It is observed that the organic product retains one or more physiological, chemical, biological and structural properties of the organic product during the first shelf life and the second shelf life. Further, a quality and freshness level of the organic product is similar to that of the fresh organic product.

Further, the organic product can be subjected to tempering by the tempering unit 1020. In an embodiment, the tempering may be done at −5 to 0 degree Celsius, to provide a preservable organic product 1022. The preservable organic product obtained as an output of the tempering unit, is similar in physical, chemical, structural and physiological characteristics of the fresh organic product. Further, the preservable organic product is preservable from 7 days to 2 years based on a type of the organic product when stored at −2 to 5 degree Celsius, which is longer than a typical shelf life of the fresh organic product.

Apart from facilitating a constant temperature of the organic product during irradiation, the apparatus 1016, can be used for various applications dealing with temperature sensitive products. In an embodiment, the apparatus disclosed in FIG. 4 can also be used for distributing the preservable organic product or the tempered organic product. The apparatus maintains the preservable organic product or the tempered organic product at a constant temperature (for example, −5 to 0 degree Celsius) during the distribution and transportation. In an embodiment, the apparatus can also be used for transporting the organic product from the freezing unit to the process plant, where the organic product is maintained at the predefined temperature selectable from 0 to −195 degree Celsius during the transportation. The thermal insulation modules in the apparatus can be used for protecting products against heat or cold during transport and storage.

For example, the apparatus can be used for storing medicines, vaccines and other medical products at low temperatures for extended durations while being transported from a manufacturing unit to a distributor outlet. Disclosed apparatus can also be used for cold storage of essential commodities such as blood plasma, and organs such eye, for a predefined time duration during instances of power outages. The apparatus can also be used to store and transport raw meat, processed seafood, and other such perishable food products at freezing or low temperatures to ensure preservation and longer shelf life.

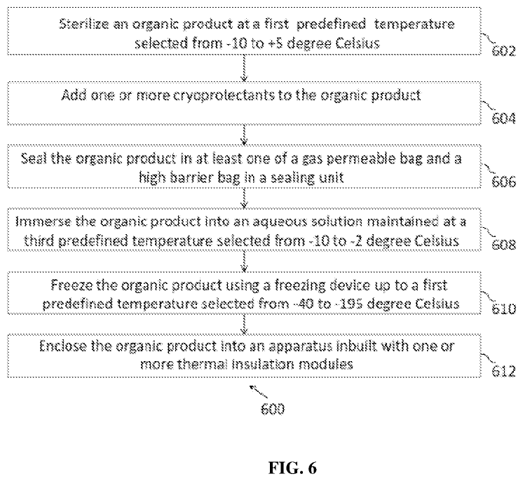

A method for preserving an organic product is explained further in reference to FIG. 5.

FIG. 5 is a flowchart 500 illustrating a method for preserving organic products. At 502, an organic product maintained at a predefined temperature or frozen up to the predefined temperature is obtained. In an embodiment, the organic product can be obtained from a freezing device (1010 as shown in FIG. 3) when subjected to a freezing process up to the predefined temperature (−40 to −195 degree Celsius). In an embodiment, the organic product is vacuum-sealed in a gas permeable bag and then in a high barrier bag (for example, a nylon bag) prior to freezing. In another embodiment, the organic product is sealed in an air-tight nylon bag alone prior to freezing. The high barrier bag or the air-tight nylon bag provides an air-tight packaging around the organic product, thereby avoiding dehydration and oxidation of the organic product as a result of the freezing process. Hence, the organic product is protected from freezer burns.

At 504, the organic product is enclosed within an apparatus (1016 (see FIG. 1), 400 (see FIG. 4)), wherein the apparatus is inbuilt with one or more phase change material (PCM) modules (408). The apparatus is enabled by the PCM modules to maintain a constant temperature level of an enclosed space (410) where the organic product (e.g. 414a) is accommodated, and thereby maintaining the organic product at the predefined temperature. The PCM modules facilitate maintaining the constant temperature level of the enclosed space and a temperature of the organic product at the predefined temperature for a predefined time period.

At 506, the organic product is irradiated for the predefined time period for effective eradication of microbial contamination in the organic product. In an embodiment, the constant temperature level inside the apparatus is selected from a range of −15 to −45 degree Celsius. Further, the predefined time period is based on a type of the organic product and is selected from a range of 5 to 180 minutes and a concentration of the gamma radiation ranges from 0.3 kGy to 50 kGy.

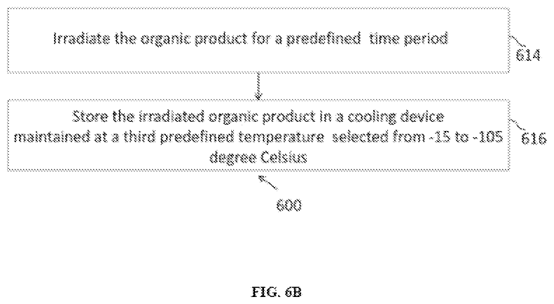

Another method of preserving organic products is explained in FIG. 6.

FIG. 6 is a flowchart 600 illustrating a method for preserving organic products. At 602, the organic product is sterilized within a sterilization device (1004, see FIG. 1) at a first predefined temperature selectable from −10 to +5 degree Celsius. The first predefined temperature is selected based on a type and quantity of the organic product.

At 604, one or more cryoprotectants and cryostabilizers are added to the organic product. In an embodiment, a cryoprotectant is one of a sucrose, chitosan, sorbate, acetic, oligochitosan, dissaccharides, glycerol, sorbitol, ascorbic acid, citric acid, amino acids, polyols, methyl amines, carbohydrates, and inorganic salts. Examples of inorganic salts include potassium phosphates, tripolyphosphate, and ammonium sulfate, carboxymethyl cellulose, gums or their combinations. Further, cryostabilizers can be selected from a group of polyols and/or polysaccharides. In an embodiment, a cryostabilizer can be one of a poly(ethylene glycol) (PEG), polyacrylamide, ficoll, pectin methylesterase and maltodextrin powder (DE=5-18). Furthermore, in an embodiment 200 ppm of cryoprotectants, and at least 0.001 mg of cryostabilizers are added to each gram of the organic product.

A cryoprotectant is selected based on a type of the organic product. The cryoprotectants added to the organic product, protect the organic product from freezing damages such as freezer burns. As a result, the loss of taste that occurs due to freezer burns is avoided. Additionally, cryoprotectants help in extending shelf life of the organic products, during freezing process or during cold storage at less than 0 degree Celsius. For example, during cold storage or freezing of a fish, the cryoprotectants stabilize the proteins present in the fish in a native form, by preventing ice crystal growth and migration of water molecules from the proteins. Specifically, addition of oligochitosan and/or chitosan not only minimizes loss of protein functionality properties that are caused by freezing but also tend to improve the texture and color of fish products. Further, addition of a cryostabilizer to the organic product, helps in reducing rancidity in the organic product during preservation and cold storage. Furthermore, disclosed cryostabilizers help in avoiding protein degradation and lipid oxidation in certain organic products such as fish, seafood, raw and processed meat, blood plasma and the like. As a result, addition of aforementioned cryoprotectants and cryostabilizers help maintain a quality of the organic products when subjected to preservations at low temperatures (less than 0 degree Celsius).

At 606, the organic product is sealed in at least one of a gas permeable bag and a high barrier bag in a sealing unit (1006, see FIG. 1). In an embodiment, the temperature of the organic product may increase from the first predefined temperature during sealing. Hence, it is essential to bring the temperature of the organic product closer to 0 degree Celsius before subjecting the organic product to freezing.

At 608, the organic product is immersed the organic product into an aqueous solution maintained at a second predefined temperature selected from a range of −20 to +2 degree Celsius, until a core temperature of the organic product reaches the temperature of the aqueous solution. In an embodiment where the aqueous solution is brine the second predefined temperature and the amount of brine solution is selected from a brine chart Immersing of the organic product in the aqueous solution is a chilling process carried out prior to the freezing the organic product, to ensure the organic product is brought close to 0 degree Celsius and to facilitate passing critical temperature of −1.5 to 5 degree Celsius in a shorter span of time during the freezing. As a result smaller uniformed sized ice crystals may be formed instead of damaging ice crystals within the organic product when subjected to the freezing, thereby improving a quality of the organic product.

At 610, the organic product is subjected to the freezing using a freezing device (101, see FIG. 1) up to a predefined temperature, wherein the predefined temperature is based on a type and composition of the organic product. In an embodiment, the predefined temperature is selected from a range of −40 to −195 degree Celsius.

At 612, the organic product is introduced into an apparatus inbuilt with one or more phase change material (PCM) modules.

At 614, the organic product is irradiated for a predefined time period effective to eradicate microbial contamination in the organic product.

At 616, the irradiated organic product is stored in a cooling device maintained at a third predefined temperature selected from −15 to −105 degree Celsius. The organic product obtains a first shelf life of up to 10 years, depending on a type of the organic product, when stored at the third predefined temperature. The organic product may be tempered for consumption. It is observed that upon tempering the organic product at −2 degrees Celsius, the organic product obtains a second shelf life of 7 days to 2 years depending on the type of the organic product, when stored at −2 to 5 degree Celsius.

Advantage of disclosed method of preservation, is a prolonged shelf life of the organic products. Another advantage of the disclosed process is the physiological, chemical, biological, and structural characteristics and organoleptic properties of the organic product obtained post preservation are similar to the fresh organic product. For example, organic product obtained by disclosed method, exhibits consistency in texture and shape, taste and color when tempered.

For example, the disclosed method of preservation results in prolonged first shelf life and second shelf life of various types of organic products as shown in the table below:

| | | First Shelf Life | Second Shelf Life |
|---|---|---|---|
| | | (stored at −15 | (stored at −2 |
| Type of Organic | Water Content | to −105 degree | to 5 degree |
| Product | (% by weight) | Celsius) | Celsius) |
| Fatty Fish (for | 80-85% | 10-12 months | 8-18 days |
| example: salmon, | | (at −15 C.) | (at 0° C.) |
| mackerel, perch, | | 4-5 years | 7-18 days |
| bluefish) | | (at −40 C.) | (at 1° C.) |
| | | 7-7.5 years | 7-15 days |
| | | (at −105 C.) | (at 3° C.) |
| Lean fish (for | 70-80% | 1.5-2.0 years | 8-18 days |
| example: cod, | | (at −15 C.) | (at 0° C.) |
| flounder, sole, | | 4.5-5.0 years | 7-18 days |
| haddock, Pollock) | | (at −40 C.) | (at 1° C.) |
| | | 7-7.9 years | 7-15 days |
| | | (at −60 C.) | (at 3° C.) |
| | | 8.5-10 years | 7-13 days |
| | | (at −105 C.) | (at 5° C.) |
| Raw Meat: (for | 64-75% | 20-24 months | 15-30 days |
| example: Beef, | | (at −15 C.) | (at 0 to 4° C.) |
| Pork, Lamb) | | 3.5 to 4.0 years | |
| | | (at −30 C.) | |
| | | 8.0-8.5 years | |
| | | (at −60 C.) | |
| | | 9-10 years | |
| | | (at −105° C.) | |
| Poultry | 50-70% | 12-15 months | 10 to 25 days |
| (for example:, | | (at −15 C.) | (at 0 to 4° C.) |
| turkey, duck, | | 2.5-3.0 years | |
| chicken) | | (at −30 C.) | |
| | | 7.0-8.0 years | |
| | | (at −105° C.) | |
| Vegetables | 30-95% | 3.0-4.0 | 13 days |
| | | (at −105 C.) | (at 0 to 5° C.) |
| Fruits | 30-95% | 3.0-3.5 years | 13 days |
| | | (at −105 C.) | (at 0 to 5° C.) |
| Rice, wheat, seeds | 12-19% | 10 years | 7.5-8.5 |
| | | (at −105 C.) | (at 0 to 5° C.) |
| dry spices | 8-23% | 8-9 years | 6.0-7.0 years |
| | | (at −105 C.) | (at 0 to 5° C.) |
| dried fruits | 3-25% | 8.5-9.0 years | 5.0-6.0 years |
| | | (at −105 C.) | (at 0 to 5° C.) |

The foregoing description of the specific embodiments reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A method for preserving an organic product in a process plant, the method comprising:
obtaining (502) the organic product; wherein the organic product is subjected to freezing at a predefined temperature;
enclosing (504, 612) the organic product within an apparatus (1016, 400), wherein the apparatus is inbuilt with one or more thermal insulation modules (408); and
irradiating (506, 614) the organic product for a predefined time period, wherein the one or more thermal insulation modules to maintain a temperature of the organic product at the predefined temperature during the predefined time period.

2. The method of claim 1, wherein obtaining the organic product further comprises:
sealing (606) the organic product in at least one of a gas permeable bag and a high barrier bag; and
freezing (610) the organic product up to the predefined temperature, wherein the predefined temperature is based on the type and composition of the organic product, and wherein the predefined temperature is selectable from a range of −40 to −195 degree Celsius.

3. The method of claim 2, wherein the freezing further comprises;
cooling a freezing solvent contained within the tank of a freezing device by at least one cooling unit coupled to the tank, wherein a cooling unit circulates a refrigerant to cool the freezing solvent up to the predefined temperature; wherein the freezing solvent is at least one of an alcohol, alkane, alkene, aldehyde and an aqueous based solution, and wherein the freezing solvent comprises at least one inhibitor;
immersing the organic product into the freezing solvent;
passing a cryogen into the freezing solvent by using a permeable structure placed inside the tank, wherein the cryogen is provided to the permeable structure in one or more of a gaseous form, a liquid form, and a combination thereof based on the predefined temperature;
circulating the freezing solvent from the tank, through a liquid transmission means and back into the tank using a pump to maintain the freezing solvent at the predefined temperature;
agitating the freezing solvent using at least one agitator placed within the tank; and
performing the steps of passing cryogen, circulating the freezing solvent, and agitating the freezing solvent, until a core temperature of the organic product reaches the predefined temperature.

4. The method of claim 3, wherein the freezing solvent is selected from one of ethanol, glycol, isopentane, 3-methylcyclohexene, 3-ethyltoluene, ethyl iodide, acetaldehyde, brine, and wherein the cryogen is one or more of helium, hydrogen, nitrous oxide, argon, nitrogen, oxygen, carbon dioxide, and Liquefied Natural Gas (LNG).

5. The method of claim 2, wherein obtaining the organic product further comprises:
sterilizing (602) the organic product at a first predefined temperature selectable from a range of −10 to +5 degree Celsius, wherein the first predefined temperature is based on a type and quantity of the organic product;
adding (604) one or more cryoprotectants and cryostabilizers to the organic product, wherein a cryoprotectant is one of a sucrose, chitosan, sorbate, acetic, oligochitosan, dissaccharides, glycerol, sorbitol, ascorbic acid, citric acid, amino acids, polyols, methyl amines, carbohydrates, and inorganic salts, and wherein a cryostabilizer is one of a poly(ethylene glycol) (PEG), polyacrylamide, ficoll, pectin methylesterase and maltodextrin powder, and
immersing (608) the organic product into an aqueous solution maintained at a second predefined temperature selectable from a range of −20 to +2 degree Celsius, until a core temperature of the organic product reaches the second predefined temperature of the aqueous solution.

6. The method of claim 1, wherein the predefined temperature is selectable from a range of 0 to −195 degree Celsius, and wherein the predefined time period is selectable from a range of 5 to 180 minutes, and wherein a concentration of radiation required for irradiating the organic product is selectable from a range of 0.3 kGy to 50 kGy, based on a type of the organic product.

7. The method of claim 1, wherein the apparatus comprises of:
a double walled container (402) having an inner wall (402b) and an outer wall (402a), wherein the one or more thermal insulation modules is disposed within a space (418) between the inner wall and the outer wall; and
at least one container (404) located within an enclosed space (410) contained by the inner wall, wherein the at least one container is filled with a cooling agent (416) to facilitate maintaining the predefined temperature of the organic product, and wherein the cooling agent comprises one or more of a dry ice, a gel pack and a Phase Change Material (PCM), and wherein the organic product is accommodated around the at least one container within the enclosed space.

8. The method of claim 1, further comprising:
storing (616) the irradiated organic product in a cooling device (1018) maintained at a third predefined temperature selectable from −15 to −105 degree Celsius, wherein the organic product has a first shelf life up to 10 years when stored at the third predefined temperature, and wherein the first shelf life is based on a type of the organic product, and wherein the irradiated organic product retains the physiological, chemical, biological and structural properties of the organic product during the first shelf life.

9. The method claim 1, wherein the irradiated organic product has a second shelf life of 7 days to 2 years based on a type of the organic product, when tempered and stored at a temperature range of −2 to 5 degrees Celsius, and wherein the irradiated organic product retains the physiological, chemical, biological and structural properties of the organic product during the second shelf life.

10. The method of claim 1, wherein the organic product is at least one of seafood, meat, poultry, vegetables, fruits, roots, seeds, microbes, fungi, albumin, proteins, gels, biological media and blood plasma.

11. The method of claim 1, wherein the one or more thermal insulation modules comprise one or more of a gel pack and a phase composition material (PCM), wherein a composition of the gel pack and the PCM is adjustable to store heat energy proportional to a temperature difference of at least 250 degree Celsius between the thermal insulation module and an environment external to the apparatus, wherein the composition of the gel pack comprises a superabsorbent polymer, water and alcohol, wherein a ratio of the water to the alcohol is 1:4, and wherein the superabsorbent polymer comprises one of polyacrylate, ethylene maleic anhydride copolymer, cross-linked carboxymethylcellulose, and polyacrylonitrile, and wherein the composition of the PCM comprises a hydrogel, filling agent and one or more nanoparticles, and wherein the hydrogel is selected from the group consisting of (1-ethyl-3-(3 dimethylaminopropyl) carbodimide hydrochloride) (EDC) and N-Hydroxysuccinimide (NHS), polyacrylates, acrylate monomers salts, Poly(γ-glutamic) Acid (PGA) crosslinked by L-lysine and Gellan gum, and polyacrylamide, and wherein the filling agent is selected from the group consisting of an alcohol, alkene, alkyne, amides, aldehyde, paraffin, fatty acid, and aqueous based solutions, and wherein the nanoparticles is selected from the group consisting of aluminum (Al), Copper (Cu), Silicon dioxide (SiO₂), Titanium Oxide (TiO₂), Carbon nanotubes (CNT), Carbon nanofibers (CNF), aluminum oxide (Al₂O₃), Sodium Hydroxide (NaOH), Potassium Hydroxide (KOH), Cupric oxide (CuO) and Zinc Oxide (ZnO).

12. The method of claim 1, wherein irradiating the organic product comprises directing by at least one irradiating unit (1014) one or more of gamma radiations, microwave radiations, electron-beam radiations, corpuscular radiations, electromagnetic radiations and combinations thereof towards the organic product, wherein the at least one irradiating unit is provided within the process plant.

13. An organic product having a first shelf life of up to 10 years when stored at a temperature selectable from −15 to −105 degree Celsius; wherein the organic product retains one or more physiological, chemical, biological and structural properties of the organic product during the first shelf life; and wherein the first shelf life is based on a type of the organic product; and wherein the organic product has a moisture content of at least 30% by weight.

14. The organic product of claim 13, wherein the organic product comprises at least 200 ppm of a cryoprotectant and at least 0.001 mg of a cryostabilizer per gram of the organic product, wherein the cryoprotectant is one of a sucrose, chitosan, sorbate, acetic, oligochitosan, dissaccharides, glycerol, sorbitol, ascorbic acid, citric acid, amino acids, polyols, methyl amines, carbohydrates, and inorganic salts, and wherein the cryostabilizer is one of a poly(ethylene glycol) (PEG), polyacrylamide, ficoll, pectin methylesterase and maltodextrin powder.

15. The organic product of claim 13, wherein the organic product has a second shelf life of 7 days to 2 years when stored at a temperature selectable from −2 to 5 degree Celsius, wherein the organic product retains one or more physiological, chemical, biological and structural properties of the organic product during the second shelf life.

16. The organic product of claim 15, wherein the first shelf life and the second shelf life of the organic product is obtained by:
sealing (606) the organic product in at least one of a gas permeable bag and a high barrier bag;
freezing (610) the organic product up to a predefined temperature, wherein the predefined temperature is based on a type and a composition of the organic product, and wherein the predefined temperature is selectable from a range of −40 to −195 degree Celsius;
enclosing (504, 612) the organic product within an apparatus (1016, 400) configured to maintain a temperature of the organic product at a predefined temperature for a predefined time period; and
irradiating (506, 614) the organic product during the predefined time period; wherein the predefined time period is selectable from a range of 5 to 180 minutes, and wherein a concentration of radiation required for irradiating the organic product is selectable from a range of 0.3 kGy to 50 kGy, based on a type of the organic product, and wherein a temperature of the organic product is maintained at the predefined temperature during the irradiation.

17. The organic product of claim 16, wherein the first shelf life and the second shelf life of the organic product is further obtained by:
sterilizing (602) the organic product at a first predefined temperature, wherein the first predefined temperature are based on a type and quantity of the organic product, wherein the first predefined temperature is selectable in a range of −10 to +5 degree Celsius; and
immersing (608) the organic product into an aqueous solution maintained at a second predefined temperature, until a core temperature of the organic product reaches the temperature of the aqueous solution, wherein the second predefined temperature is selectable in a range of −20 to +2 degree Celsius, and wherein the step of sterilizing, sealing, and immersing of the organic product is performed prior to the step of freezing.

18. The organic product of claim 13, wherein the organic product is at least one of seafood, meat, poultry, vegetables, fruits, roots, seeds, microbes, fungi, gels, albumin, proteins, biological media and blood plasma.

19. The organic product of claim 16, wherein the apparatus comprises:
a double walled container (402) having an inner wall (402b) and an outer wall (402a), wherein the one or more thermal insulation modules is disposed in a space (418) existing between the inner wall and an outer wall, and wherein the one or more thermal insulation modules is configured to maintain a temperature of the organic product at the predefined temperature for the predefined time period, and wherein the organic product is placed within an enclosed space (410) contained by the inner wall of the double walled container; and
at least one container (404) disposed within the enclosed space, wherein the at least one container is filled with a cooling agent (416) to further maintain the temperature of the organic product at the predefined temperature for the predefined time period.

20. The organic product of claim 19, wherein the cooling agent comprises one or more of a dry ice, a gel pack and a Phase Change Material (PCM), and wherein a thermal insulation module comprises one or more of a phase change material (PCM) and a gel pack, and wherein a composition of the gel pack and the PCM adjustable to store heat energy proportional to a temperature difference of at least 250 degree Celsius between the thermal insulation module and an environment external to the apparatus.

21. An apparatus (1016, 400) comprising:
a double walled container (402) containing an organic product (304a-n) within an enclosed space (410) and configured to maintain a temperature of the organic product at a predefined temperature for a predefined time period; and
at least one container (404) disposed within the enclosed space is configured to facilitate maintaining the temperature of the organic product at the predefined temperature for the predefined time period, wherein the at least one container is filled with a cooling agent (416).

22. The apparatus of claim 21, wherein the double walled container includes:
an inner wall (402b);
an outer wall (402a), and
one or more thermal insulation modules (408) disposed within a space (418) existing between the inner wall and an outer wall, and wherein a thermal insulation module comprises one or more of a phase change material (PCM) and a gel pack; and wherein the one or more thermal insulation modules is configured to maintain the temperature of the organic product at the predefined temperature for the predefined time period.

23. The apparatus of claim 22, and wherein a composition of the gel pack and the PCM is adjustable to store heat energy proportional to a temperature difference of at least 250 degree Celsius between the thermal insulation module and an environment external to the apparatus.

24. The apparatus of claim 23, wherein the composition of the gel pack comprises a superabsorbent polymer, water and alcohol, wherein a ratio of the water to the alcohol is 1:4, and wherein the superabsorbent polymer comprises one of polyacrylate, ethylene maleic anhydride copolymer, cross-linked carboxymethylcellulose, and polyacrylonitrile,

25. The apparatus of claim 23, wherein the composition of the PCM comprises a hydrogel, filling agent and one or more nanoparticles, and wherein the hydrogel is selected from the group consisting of (1-ethyl-3-(3 dimethylaminopropyl) carbodimide hydrochloride) (EDC) and N-Hydroxysuccinimide (NHS), polyacrylates, acrylate monomers salts, Poly(γ-glutamic) Acid (PGA) crosslinked by L-lysine and Gellan gum, and polyacrylamide, and wherein the filling agent is selected from the group consisting of an alcohol, alkene, alkyne, amides, aldehyde, paraffin, fatty acid, and aqueous based solutions, and wherein the nanoparticles is selected from the group consisting of aluminum (Al), Copper (Cu), Silicon dioxide (SiO₂), Titanium Oxide (TiO₂), Carbon nanotubes (CNT), Carbon nanofibers (CNF), aluminum oxide (Al₂O₃), Sodium Hydroxide (NaOH), Potassium Hydroxide (KOH), Cupric oxide (CuO) and Zinc Oxide (ZnO).

26. The apparatus of claim 21, wherein the double walled container further includes an opening (406) through which the organic product is introduced into the enclosed space, and wherein the organic product is packed in an insulated structure (412a-n), and wherein the organic product is subjected to freezing up to the predefined temperature prior to the introduction into the enclosed space.

27. The apparatus of claim 21, wherein the cooling agent comprises one or more of a dry ice, a gel pack and a Phase Change Material (PCM).

28. The apparatus of claim 21, wherein the double walled container can be composed of one or more of an aluminum, carbon steel, iron material, fiberglass, stainless steel and a combination thereof, and wherein the at least one container is composed of one or more of an aluminum, carbon steel, iron, fiberglass, steel and a combination thereof.

29. The apparatus of claim 21, wherein the predefined temperature is selectable from a range of 0 to −195 degree Celsius, and wherein the predefined time period is selectable from a range of 5 to 180 minutes, and wherein a temperature external to the apparatus ranges from 0 to 55 degree Celsius.

30. The apparatus of claim 21, wherein the apparatus is further configured to maintain the temperature of the organic product at the predefined temperature when the organic product is irradiated by one or more radiations emitted by at least one irradiating unit (1014) installed within a process plant for the predefined time period and when a temperature external to the apparatus ranges from 0 to 55 degree Celsius, wherein the predefined temperature is selectable from a range of −40 to −195 degree Celsius, the predefined time period is selectable from a range of 5 to 180 minutes, and a concentration of radiation provided for irradiating the organic product is selectable from a range of 0.3 kGy to 50 kGy, based on a type of the organic product, and wherein the at least one irradiating unit (1014) is one of a gamma radiation unit, an electron-beam emission unit, a microwave radiation unit, an electromagnetic radiation unit, a corpuscular radiation unit.
